(19) United States
(12) Patent Application Publication
(10) Pub. No.: US 2025/0261294 A1
(43) Pub. Date: Aug. 14, 2025

(54) LED LIGHTING WITH LIGHT TO LIGHT BLE PAIRING PROCESS AND WIFI CONTROLS

(71) Applicant: LEDVANCE LLC, WILMINGTON, MA (US)

(72) Inventor: Gerardo Cisneros, Buena Park, CA (US)

(21) Appl. No.: 19/051,533

(22) Filed: Feb. 12, 2025

Related U.S. Application Data
(60) Provisional application No. 63/552,485, filed on Feb. 12, 2024.

(51) Int. Cl. H05B 47/19

(52) U.S. Cl. CPC H05B 47/19

(57) ABSTRACT

A light control system that includes a controller having at least one transceiver for communication with a mesh network using a first wireless signal based on a BLE standard for configuring the mesh network and sending a second wireless signal based on a WiFi standard for issuing control commands. The light control system also includes at least one luminaire in the mesh network. The at least one luminaire including a light source including a light emitting diode (LED), a driver for providing electrical signal to the light source, a luminaire controller for controlling the electrical signal from the driver to the light source, memory including a network address and a transceiver for communicating with the controller using the first and second wireless signal.

### TECHNICAL FIELD

The present disclosure generally relates to wirelessly controlled systems, and more particularly to wireless based networks of electrical devices.

### BACKGROUND

Home and professional environments can contain many controllable wireless devices, such as lighting devices for the creation of ambient, atmosphere, accent or task lighting. These controllable lighting devices are often connected and controlled via a network. These wireless devices can be controlled individually or in groups via a wireless based lighting control.

### SUMMARY

A network control system is provided that employs two wireless control signals to initiate and control a network of wireless devices. The network of wireless devices can be established using a first wireless signal based on the BLE standard, e.g., BLE mesh. Control of the devices within the network may include a second wireless signal based on a WiFi standard, e.g., IEE 802. The network of wireless devices is in communication with a remote control. The remote control can be a wall switch. The remote control includes at least one transceiver for communicating with the first wireless signal and communicating with the second wireless signal.

In one aspect, a network control system is provided that employs two wireless control signals to initiate and control a network of wireless devices. The network of wireless devices can be established using a first wireless signal based on the BLE standard, e.g., BLE mesh. Control of the wireless devices in the network may include a second wireless signal based on a WIFI standard, e.g., IEE 802. The network of wireless devices can be in communication with a remote control, that can be a wall switch. The remote control includes at least one transceiver for receiving the first wireless signal and the second wireless signal.

In an embodiment, a light control system is provided that includes a controller having at least one transceiver for communication with a mesh network using a first wireless signal based on a BLE standard for configuring the mesh network and sending a second wireless signal based on a WiFi standard for issuing control commands. The light control system also includes at least one luminaire in the mesh network. The at least one luminaire including a light source including a light emitting diode (LED), a driver for providing electrical signal to the light source, a luminaire controller for controlling the electrical signal from the driver to the light source, memory including a network address and a transceiver for communicating with the controller using the first and second wireless signal.

In another aspect, a method of wireless device control is provided that includes providing a controller having a user interface for selecting wireless device performance, and at least one transceiver for communication using a first wireless signal based on a Bluetooth standard and a second wireless signal based on a WiFi standard. The method may further include initiating a mesh network of at least one wireless device. The wireless device including a transceiver for communicating with the controller using the first and second wireless signal. In one example, initiating the mesh network includes linking to the controller to the mesh network using the first wireless signal. The method may further include controlling the at least one wireless device in the mesh network from the controller. Controlling the wireless devices can include sending control signals using the second wireless signal to the at least one wireless device in the mesh network.

In another embodiment, a method of lighting control is provided that includes providing a controller having a user interface for selecting lighting characteristics, and at least one transceiver for communication using a first wireless signal based on a Bluetooth standard and a second wireless signal based on a WiFi standard. The method may further include initiating a mesh network of at least one luminaire in the mesh network. In one example, the at least one luminaire can include a light source including a light emitting diode (LED), a luminaire controller for controlling the electrical signal to the light source, memory including a network address and a transceiver for communicating with the controller using the first and second wireless signal. In some embodiments, initiating the mesh network includes linking to the controller to the mesh network using the first wireless signal. In some embodiments, the method also includes controlling the at least one luminaire in the mesh network from the user interface for selecting light characteristics for light emitted by the light source. Controlling the at least one luminaire includes sending control signals for the lighting characteristics selected from the user interface using the second wireless signal to the at least one luminaire in the mesh network.

In yet another embodiment, a computer program product is provided for lighting control comprising a computer readable storage medium having computer readable program code embodied therewith, the program instructions executable by a processor to cause the processor to: configure, using a processor, a controller having a user interface for selecting lighting characteristics, and at least one transceiver for communication using a first wireless signal based on a Bluetooth standard and a second wireless signal based on a WiFi standard. The computer implemented method can further include initiating, using the processor, a mesh network of at least one luminaire in the mesh network, the at least one luminaire including a light source including a light emitting diode (LED), a luminaire controller for controlling an electrical signal to the light source, memory including a network address and a transceiver for communicating with the controller using the first and second wireless signal, wherein said initiating the mesh network includes linking to the controller to the mesh network using the first wireless signal. The computer implemented method can further control, using the processor, the at least one luminaire in the mesh network from the user interface for selecting light characteristics for light emitted by the light source, wherein the controlling the at least one luminaire includes sending control signals for the lighting characteristics selected from the user interface using the second wireless signal to the at least one luminaire in the mesh network.

These and other features and advantages will become apparent from the following detailed description of illustrative embodiments thereof, which is to be read in connection with the accompanying drawings.

### BRIEF DESCRIPTION OF THE DRAWING

The following description will provide details of embodiments with reference to the following figures wherein:

FIG. 1 is an illustration depicting a general environment in which a mesh network of luminaires is provisioned using a first wireless signal, and then controlled using a second wireless signal from a controller, in accordance with an embodiment of the present disclosure.

FIG. 2 is a perspective exploded view of a luminaire having a downlight form factor including transceivers that employs two wireless signal types, e.g., a first wireless signal based on a Bluetooth standard, and a second wireless signal based on a WiFi standard, in accordance with an embodiment of the present disclosure.

FIG. 3 is a top view of the luminaire depicted in FIG. 2, in accordance with an embodiment of the present disclosure.

FIG. 4 is a bottom view of the luminaire depicted in FIG. 2, in accordance with an embodiment of the present disclosure.

FIG. 5 is a side view of the luminaire depicted in FIG. 2, in accordance with an embodiment of the present disclosure.

FIG. 6 is an exploded view of the luminaire depicted in FIG. 2, in accordance with an embodiment of the present disclosure.

FIG. 7 is a top down view of a light engine including light emitting diodes (LEDs), in accordance with an embodiment of the present disclosure.

FIG. 8 is a block diagram of a circuit for the luminaire depicted in FIG. 2, in accordance with an embodiment of the present disclosure.

FIG. 9 is a circuit diagram for the driver electronics of the luminaire, in accordance with an embodiment of the present disclosure.

FIG. 10 is a front view of a controller for the lighting network control system that employs a first wireless signal to provision a network of luminaires and a second wireless signal to control the lighting characteristics for the light emitted by the network of luminaires, in accordance with one embodiment of the present disclosure.

FIG. 11 is a block diagram of a controller for the lighting network control system that employs a first wireless signal to provision a network of luminaires and a second wireless signal to control the lighting characteristics for the light emitted by the network of luminaires, in accordance with one embodiment of the present disclosure.

FIG. 12 is a block diagram of a computer implemented method for providing a wireless control system that employs two wireless signals for operation, in accordance with one embodiment of the present disclosure.

### DETAILED DESCRIPTION

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

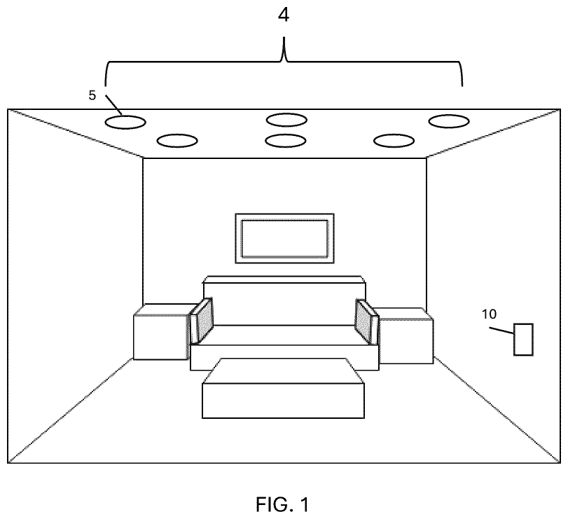

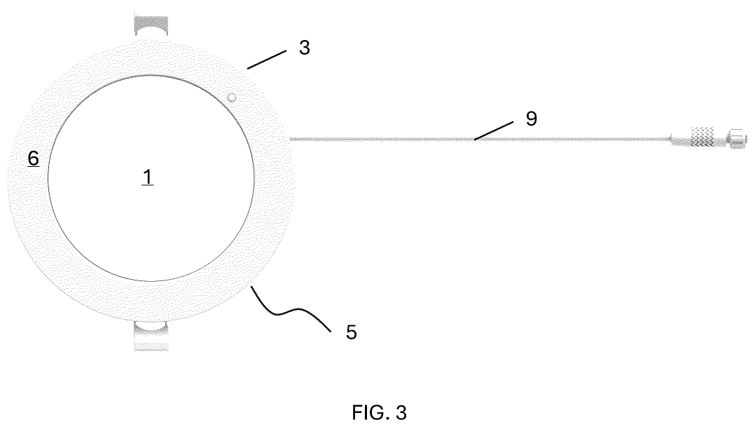

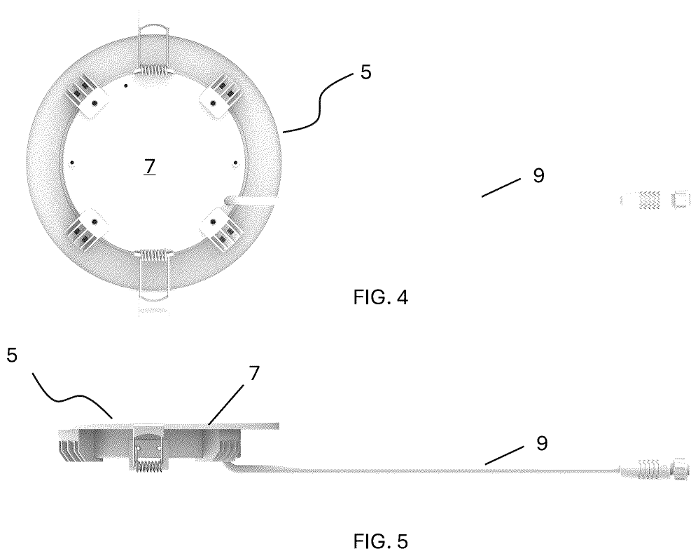

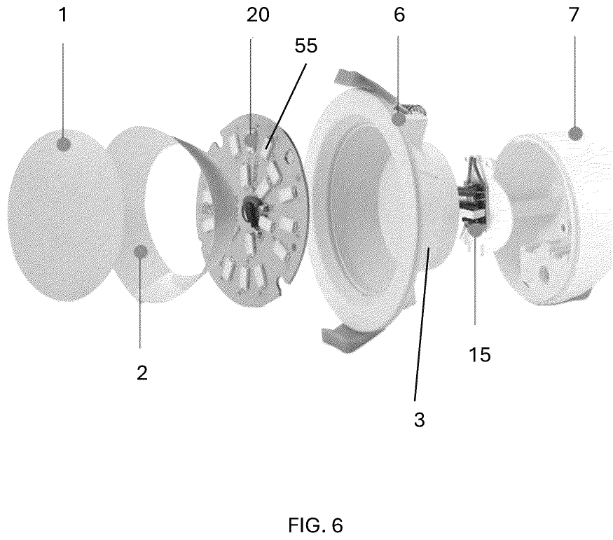

The systems, structures and methods of the present disclosure provide a wireless control system that employs two wireless signals for operation. In some embodiments, a first wireless signal may be a Bluetooth based signal that can be used for provisioning a mesh network of at least one wireless device. In some embodiments, a second wireless signal may be a WiFi signal used to control wireless devices operations, such as the functions and performance of the at least one wireless device, using a controller. The controller can be a wall switch. The systems, structures and methods of the present invention can provide for simplified provisioning and control of a mesh network of wireless devices solely through the wireless devices and wireless device specific controllers without requiring any additional bridge type structures and computing interfaces separate from the controller. The systems and methods of the present disclosure are not described in greater detail with reference to FIGS. 1-11. It is noted that in the following description, the wireless devices being controlled by the system are luminaires 5. It is not intended that the present disclosure be limited to wireless control of luminaires 5, as any wireless device is suitable for being controlled by the systems described herein.

FIG. 1 is an illustration depicting a general environment in which a mesh network 4 of luminaires 5 is provisioned using a first wireless signal, and then controlled using a second wireless signal from a controller 10.

In one embodiment, a lighting control system is used to provisional and control lighting in the general environment that is depicted in FIG. 1. The lighting control system includes a controller 10 having at least one transceiver for communication with a mesh network using a first wireless signal based on a Bluetooth standard for configuring the mesh network 4, and sending a second wireless signal based on a WiFi standard for issuing control commands. In examples, to configure a mesh network may include provisioning at least one luminaire 5 in the mesh network 4 for initial set up or adding an additional luminaire 5 to an existing network. “Provisioning” is the process of setting up a network of luminaires 5 so that the controller 10 can access it. In practice, provisioning concerns connectivity and security, which means a heavy focus on device and identity management.

In some embodiments, the control system 100 can provision the mesh network 5 of the at least one luminaire 5 using a first wireless signal based on a Bluetooth standard. In some embodiments, the Bluetooth standard using in the lighting control system is Bluetooth mesh. “Bluetooth Mesh” is a computer mesh networking standard based on Bluetooth Low Energy that allows for many-to-many communication over Bluetooth radio.

In some examples, “Bluetooth Mesh” is a mesh networking standard that operates on a flood network principle. For example, Bluetoooth Mesh can be based on the nodes relaying messages. A node is a device that is provisioned to be part of a given network segment. Every relay node can receive a message including a network packet that authenticates against a known network key. This means that the devices for the nodes have had network-specific encryption keys loaded onto it so it can exchange messages with its peers. There are several different sets of encryption keys possible for each device. In some embodiments, the relay nodes may be the luminaires 5. However, as noted above, other types of wireless devices may be controlled using the system described herein, which may also function as relay nodes.

As will be described below, each of the luminaires 5 may include a transceiver for transmitting and receiving the first signal, e.g., Bluetooth signal. The use of the transceiver in the luminaire to transmit and receive the Bluetooth signal is one mechanism by which the luminaire 5 functions as a node in the provisioning of the mesh network 4. The maximum number of nodes in any given Bluetooth mesh network is 32,767, with up to 4,096 subnets and 65,535 scenes.

Unlike traditional IP-based networks, Bluetooth Mesh uses a managed flood routing model for forwarding messages from one node to another. In this model, messages are broadcast to each node in the vicinity and a time-to-live (TTL) is used to address the potential of a routing loop. By decrementing the TTL as the message transits each node, if the TTL should reach zero, the message will be dropped at that node.

The control model used by the mesh network 4 of the luminaires 5 is a client/server architecture. In some embodiments, each luminaire 5, which functions as a node in the mesh network, can act as both a client and a server, which makes the network more resilient and scalable.

The luminaires 5 have some functionals that are controlled through the first wireless signal provided by the BLE mesh signal. For example, settings such a grouping of luminaires 5 in the network 5 can be controlled using controller 10, in which the both the controller 10 and the luminaires 5 in the mesh network have a transceiver for sending and receiving Bluetooth mesh signals.

In this example, the controller 10 and the luminaires 5 have transceivers for sending and receiving the first wireless signal. Bluetooth mesh communicates via messages. Unlike traditional IP-based networks, Bluetooth mesh uses a managed flood routing model for forwarding messages from one node to another. In the present case, the nodes are provided by the luminaires 5. Nodes in the Bluetooth mesh network communicate with each other using a publish/subscribe model, where publishers can send messages to a group of subscribers. The mesh topology enables the communication of many-to-many, which makes the networks robust and self-healing. Nodes on a Bluetooth mesh network send out a heartbeat message to ensure connectivity.

Adding a new device to the Bluetooth mesh network is called provisioning, and the device that helps with the provisioning process is called a provisioner. In some embodiment, the controller 10 can be the provisioner. Once provisioned, the network starts working, and the nodes provided by the luminaires 5 can communicate with each other directly. In some embodiments, provisioning is the process of enabling a new luminaire 5 to join the network 4 by adding security keys, setting subnets, etc. The overall flow of the provisioning process is: (1) beaconing (periodic broadcast), (2) invitation, (3) exchange of public keys, (4) authentication, and finally (5) distribution of provisioning data.

The new luminaire 5 sends out a beacon looking for an invitation to join a network. In some embodiments of the present disclosure, the luminaire 5 of the present system automatically sends out the beacon signal upon being powered. The luminaire 5 that is added by provisioning sends out the beacon signal without any additional input, such as through activation buttons, by the user. The beacon signal could be sent out for a predetermined time period, e.g., 30 seconds.

Once the luminaire 5 being provisioned receives the invitation, the luminaire 5 will send a capabilities protocol data unit (PDU) that informs the provisioner, e.g., controller 10, of the number of elements on the luminaire 5 in the network 4. The PDU unit also includes a set of security algorithms the device supports, the availability of its public key using out-of-band (OOB) technology such as a QR or bar code, the ability for this device to output a value to the user, and the ability of the device to allow input from the user. With this information, the provisioner, e.g., controller 10, can determine how to exchange security keys with the device.

Messages for setting up the network 4 can be encrypted and authenticated. Authentication is handled via the secure exchange of random numbers known as “nonces.” Depending on the capabilities of the unprovisioned device, e.g., luminaire 5, the nonce can be generated by the provisioning device and acknowledged on the unprovisioned device or vice versa or both. Confirmations are then exchanged to verify that the nonces are correct. Once the authentication is complete, the actual provisioning data can be sent to the new device and the device is now known as a network node. This provisioning data includes the overall network encryption key, the unique per-device key, some bookkeeping data, and a unicast address that will be the network address for the primary element on the new node. At this point, the node is provisioned and can start communicating on the network.

Details of the beaconing step for provisioning can include where the unprovisioned device announces its availability to be provisioned by sending the mesh beacon advertisements in the advertisement packets. In some embodiments, the luminaire 5 that is being provisioned at this step triggers this process automatically upon powering, without relying upon button presses on the unprovisioned device.

In some embodiments, an invitation step includes when the provisioner, e.g., controller 10, discovers the unprovisioned device, e.g., luminaire 5, via the beacons that were sent. The provisioner, e.g., controller 10, sends an invitation to this unprovisioned device. This uses a new type of PDU introduced in Bluetooth mesh called the provisioning invite PDU. The unprovisioned device, e.g., luminaire 5, then responds with information about its capabilities in a provisioning capabilities PDU, which includes: 1) the number of elements the device supports, 2) the set of security algorithms supported, 3) the availability of its public key using an Out-of-Band (OOB) technology, 4) the ability of this device to output a value to the user, and 5) the ability of this device to allow a value to be input by the user.

In some embodiments, following the invitation step, provisioning includes a public key exchange. Security in Bluetooth mesh can involve the use of a combination of symmetric and asymmetric keys, such as the Elliptic-curve Diffie-Hellman (ECDH) algorithm.

In some embodiments, following the key exchange, provisioning continues with authentication. Authentication of the unprovisioned device. Authentication usually requires an action by the user to interact with both the provisioner and the unprovisioned device. For example, the authentication method depends on the capabilities of both devices used. In one case, called the output out of band (OOB) signal, the unprovisioned device could output a random single-or multiple-digit number to the controller in some form. That number is then input into the luminaire 5 being provisioned via some input method. Confirmation can be achieved using a confirmation button on the exterior of the luminaire. Pressing the button may be a confirmation check step.

Provisioning data distribution can be performed after authentication is complete, each device derives a session key using its private key, and the public key is sent to it from the other device. The session key is then used to secure the connection for the exchange of additional provisioning data, including the network key (NetKey), a device key, a security parameter known as the IV index, and a unicast address which is assigned to the provisioned device, e.g., luminaire 5, by the provisioner 10. After this step, the unprovisioned device becomes known as a node.

Referring to FIG. 1, following provisioning of the mesh network 4 of luminaires 5 using the first wireless signal, the network 4 can then be controlled using a second wireless signal from the controller 10. The second wireless signal may be a WiFi signal. In some embodiments, the WiFi standard for the first wireless signal is based on the IEEE 802 standard. For example, the second wireless signal using the WiFi standard includes a 2.4 GHz WiFi band.

The second wireless signal can be based upon IEEE 802.11, which is for wireless LANs (WLANs), also known as Wi-Fi. 802.11 is a family of specifications for wireless local area networks (WLANs) developed and maintained by a working group of the Institute of Electrical and Electronics Engineers (IEEE). The 802.11 is a wireless networking standard having technical specifications that govern the implementation of Wi-Fi networks for device compatibility and connectivity. Built into the 802.11 specification family are best practices, physical hardware-layer requirements and algorithms to address resource contention on shared networks. 802.11 specifies the interface that enables over-the-air signaling between two or more wireless clients, e.g., between the controller 10 and the mesh network 4 of the luminaires 5. Each version of 802.11 spells out a theoretical performance limit, such as data throughput, signal range, network bandwidth and radio frequencies.

The earliest 802.11 iterations focused on improving speeds and data rates. The initial 802.11 spec specified operations in the 2.4 gigahertz (GHz) ISM band, with a top speed of about 2 megabits per second (Mbps), well below the gigabit-level data rates of a modern WLAN. With each technological advance, the amended specification has been identified by adding a suffix of one or two letters to the 802.11 nomenclature. Over time, the string of letters and numbers created confusion for enterprises trying to evaluate the capabilities of vendor products.

WLAN channels rely on networking equipment engineered for high performance. 802.11 deploys six half-duplex, over-the-air modulation techniques that share the same network protocol layer. 802.11 makes several radio frequencies that Wi-Fi devices use to communicate, including the 900 megahertz, 2.4 GHz, 3.6 GHz, 4.9 GHZ, 5 GHZ, 5.9 GHZ, 6 GHz and 60 GHz bands. Each frequency can be subdivided into multiple channels.

The original modulation used in 802.11 was binary amplitude-shift keying, binary frequency-shift keying, binary phase-shift keying and other schemes, such as complementary code keying. Those methods were simpler with regard to designing circuits, but they provided a limited bit rate. Newer modulation methods have emerged that provide higher data speed and reduce a network's vulnerability to interference.

Orthogonal frequency-division multiplexing (OFDM) has gained increasing prominence since the launch of 802.11a, as it expands the number of clients that can connect to a shared wireless access point. OFDM may be used in tandem with other modulation techniques, such as quadrature amplitude modulation (QAM).

802.11 specifies the use of carrier sense multiple access/collision avoidance, an algorithm that manages path sharing between two transmitting stations. The methodology is similar to IEEE's 802.3 standard for Ethernet networks, although it differs in implementation. Ethernet uses a full-duplex model for collision avoidance, where the network can listen and talk to devices at the same time. To prevent signals from colliding, Ethernet only allows a signal to be sent once acknowledgement is received that the transmission line is clear. By contrast, a Wi-Fi network uses a half-duplex model, where it can listen or speak but not do both simultaneously. Wi-Fi uses a media access protocol known as the distributed coordination function (DCF) to monitor signal traffic. If a client on the receiving end doesn't acknowledge a transmission, DCF presumes a collision has occurred and waits a given amount of time before attempting to retransmit the wireless signal.

The second wireless signal that is used by the controller 10 to send control signals to the mesh network 4 of the luminaires 5 employes a WiFi standard as described above. Specific examples of IEEE 802.11 specification signal communication between the controller 10 and the mesh network 4 of luminaires 5 may include the following:
802.11 is a technology specified into two spread-spectrum methods in the 2.4 GHz band: frequency hopping and direct sequence, each at 1 Mbps or 2 Mbps, along with diffuse infrared at 1 Mbps.
802.11b boosted speed to 11 Mbps using direct sequence spread spectrum (DSSS) in 2.4 GHz. It also accommodated weak signals by maintaining lower DSSS modes and emerged as the signature WLAN technology.
802.11a uses an OFDM physical layer in the 5 GHz band to transmit up to 54 Mbps. The advantage of 5 GHz is it's less crowded, but the higher frequency can limit its effective signal range.
802.11g uses OFDM in the 2.4 GHz band to achieve similar 54 Mbps transmission, excluding forward error correction. However, this approach also is subject to signal interference from nearby devices. 802.11g and 802.11b equipment are compatible, and vendor equipment carries both designations.
802.11n, also referred to as Wi-Fi 4, marked the start of new Wi-Fi standards branding. All 802.11n wireless products support multiple input, multiple output (MIMO) technology, in which multiple transmitters and receivers are used to transfer more data at the same time. The addition of multiple antennas boosts the theoretical data rate to 450 Mbps in 2.4 GHz operation. 802.11n reportedly is backward-compatible with 802.11a, 11b and 11g networks.
802.11ac, also known as Wi-Fi 5, pivots off amendments to 802.11n. Maximum data rates reach the gigabyte level in 5 GHz operation, with expanded channel width, twice the number of spatial streams, 256 QAM bandwidth increases and enhanced multiuser MIMO.
802.11af enables WLAN operation in very high frequency and ultra high frequency bands normally reserved for TV broadcast signals.
802.11ah describes WLANs with low power consumption that could power extended-range hotspots or serve to handle traffic overloads on a cellular network. 802.11ah-enabled WLANs can provide an alternative to short-range Bluetooth connectivity.
802.11aj, also called the Chinese Millimeter Wave frequency band, is for WLANs in China and other regions. It provides backward compatibility with 802.11ad, which is in review.
802.11ax, also known as Wi-Fi 6, uses the 2.4 GHz and 5 GHz frequency bands but has the option to use 6 GHz.
802.11be, also known as Wi-Fi 7, provides speeds of up to 46 gigabits per second (Gbps). Quadrature Amplitude Modulation (QAM) is a method to transmit and receive data in radio-frequency waves. The higher it is, the more information you can pack in. Wi-Fi 7 supports 4K-QAM, while Wi-Fi 6 supported 1,024-QAM, and Wi-Fi 5 was limited to 256-QAM.

The controller 10 using the second wireless signal (based on a WiFi standard) to control the luminaires, transmits the second wireless signal solely (directly) from the controller 10 to the mesh network 4 without needing a separate internet connection. More particularly, the second wireless signal is sent directly from the controller 10 to the network 4 of luminaires directly without requiring any additional gateways or bridges. The controller 10 and the mesh network 4 may be a closed system, which does not require an external internet based network for either of the provisioning or control functions of the light control system.

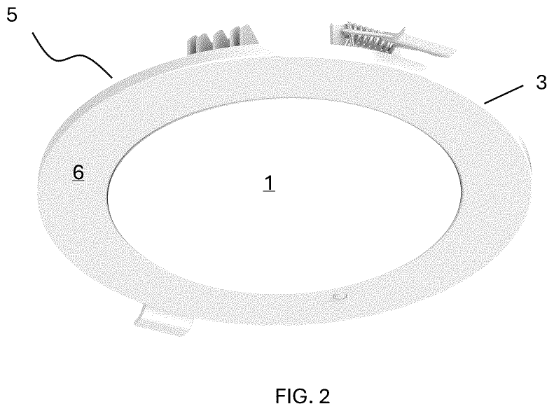

As illustrated in FIGS. 2-6, the luminaires 5 may be down can luminaires including a light engine that employs at least one light emitting diode (LED), but the present disclosure is not limited to only this type of lighting. Any type of form factor may be employed for the luminaires 5 that are employed in the light control system that is described herein. For example, the form factor for the luminaires 5 can be selected to be controlled by the controller 10 can include hanging pendant lamp, desk lamp, table lamp, floor lamp, chandelier lamp, recessed can downlight, light sources having a heat sinks, and 2×2 and/or 2×4 tube lighting office type fixtures. Further, each network may have any number of luminaires. For example, the present disclosure is not limited to a mesh network of only six luminaires 5, as depicted in FIG. 1. Any number of luminaires 5 may connect with the network. For example, the number of luminaires 5 that are connected to the network may be equal to 1, 10, 15, 20, 30, 40, 50, 100 and combinations thereof, as well as any range including one of the aforementioned examples for a lower limit of the range, and one of the aforementioned examples for an upper limit of the range.

FIG. 1 illustrates one embodiment of a luminaire 5 having a downlight form factor, in which the luminaire 5 includes a light engine having a plurality of solid state light emitters, e.g., light emitting diodes (LEDs) 50 that can be used in the control systems of the present disclosure. A “downlight”, or recessed light, (also pot light in Canadian English, sometimes can light in American English) is a light fixture that is installed into a hollow opening in a ceiling. When installed it appears to have light shining from a hole in the ceiling, concentrating the light in a downward direction as a broad floodlight or narrow spotlight. “Pot light” or “canister light” implies the hole is circular and the lighting fixture is cylindrical, like a pot or canister

Broadly, the luminaire 5 of the present disclosure is a downlight fixture that includes: a two-piece housing (light emission face panel 3 and light body 7); reflector 2; optical lens 1; light engine 20 and driver 15. In some embodiments, the light emission face panel 3 of the luminaire includes a recessed down lamp geometry for containing a light emitting diode (LED) light source. The light emission face may be composed of a metal, such as aluminum or plastic. The portion of the light emission face panel 3 that is visible when the luminaire 5 is installed in the ceiling is the trim 6. The trim 6 is the insert that is seen when looking up into the fixture, and also includes the thin lining around the edge of the light. The light emission face panel 3 is the portion of the fixture that includes the reflector 2 and the light engine 20. It is noted that embodiments are contemplated in which the trim 6 and the light emission face panel 3 are integrated together in one piece, and there are embodiments in which the trim 6 and the light emission face panel 3 are separate components.

The trim 6 of the downlight is selected to increase the aesthetic appearance of the lamp. In some embodiments, the trim 6 may be a baffle that is black or white in color. In some embodiments, the trim 6 is made to absorb extra light and create a crisp architectural appearance. There are cone trims which produce a low-brightness aperture. In some embodiment, the trim 5 may be a multiplier that is designed to control the omnidirectional light from the light engine. Lens trim is designed to provide a diffused light. Lensed trims are normally found in wet locations. The luminous trims combine the diffused quality of lensed trim but with an open down light component. Adjustable trim allows for the adjustment of the light whether it is eyeball style, which protrudes from the trim or gimbal ring style, which adjusts inside the recess.

There are many different types of light engines 20 that can be inserted into recessed lighting fixtures, i.e., downlights. In accordance with the embodiments of the present disclosure, the light engines 20 applicable to the methods and structures described herein include solid state emitters, such as light emitting diodes (LEDs) 55.

The light engine 20 may be installed in an opening in the light emission face panel 3, and a reflector 2 may be positioned around a perimeter of the light engine 20. The reflector 2 are designed to reflect light in a specific direction, and when paired with a light source, such as the light engine 20 of LEDs 55, they can create a powerful and focused beam of light. There are different types of reflectors, each with their own unique qualities and benefits. In some embodiments, the reflector 2 may be composed of polymethyl methacrylate (PMMA), polycarbonate (PC), hyper reflective polycarbonate (HRPC), and polished or coated aluminum.

In some embodiments, an optical lens 1 may enclose the light engine 20 within the light emission face panel 3. A given optical lens 1 may be configured to transmit, in part or in whole, emissions received from a given string of LEDs 55 of the light engine 20 that is positioned behind the optical lens. The optical lens 1 may be formed from any one, or combination, of suitable optical materials. For instance, in some embodiments, the optical lens 1 may be formed from a polymer, such as poly (methyl methacrylate) (PMMA) or polycarbonate, among others. In some embodiments, the optical lens 1 may be formed from a ceramic, such as sapphire (Allow₃) or yttrium aluminum garnet (YAG), among others. In some embodiments, the optical 1 may be formed from a glass. In some embodiments, the optical lens 1 can be formed from a combination of any of the aforementioned materials. Furthermore, the dimensions and geometry of the optical lens 1 may be customized, as desired for a given target application or end-use. In some embodiments, the optical lens 1 may be or otherwise include a lens, such as a Fresnel lens, a converging lens, a compound lens, or a micro-lens array, to name a few. In some embodiments, the optical lens 1 may be or otherwise include an optical dome or optical window. In some cases, the optical lens 1 may be formed as a singular piece of optical material, providing a monolithic optical structure. In some other cases, the optical lens 1 may be formed from multiple pieces of optical material, providing a polylithic (multi-piece) optical structure. In some instances, the optical lens 1 may be configured to filter light transmitted there through. Other suitable configurations for optic(s) 1 will depend on a given application and will be apparent in light of this disclosure.

The driver 15 is present on the opposite side of the light emission face panel 3 that the light engine 20 is positioned on. The driver 15 is positioned between a backside surface of the light emission face panel 3 and the light body 7. The driver 15 may be enclosed between the light emission face panel 5 and the light body 7, but wiring from the driver 15 may extend through an opening in the backside of the light emission face panel 5 into electrical communication with the light engine 20 including the light emitting diodes 5.

The light emission face panel 3 and the light body 7 together can provide the light housing that contains the light emitting diode (LED) light engine 20, as well as the driver electronics 15. The light housing may be composed of a metal, such as aluminum (Al), which provides for heat dissipation of any heat produced by the light engine. In some embodiments, to provide for increased heat dissipation, a plurality of ridges or fin structures may be integrated into the aluminum housing, e.g., the backside of the light body 7. In some embodiments, the light housing may also be composed of a plastic, such a polycarbonate. The construction of the light housing may fall into one of four categories for downlights that are recognized in North America. For example, the housing may be constructed for IC or “insulation contact” rated new construction housings are attached to the ceiling supports before the ceiling surface is installed. If the area above the ceiling is accessible these fixtures may also be installed from within the attic space. IC housings are typically reqharrityhuired wherever insulation will be in direct contact with the housing. Non-IC rated new construction housings are used in the same situations as the IC rated new construction housings, only they require that there be no contact with insulation and at least 3 in (7.6 cm) spacing from insulation. These housings are typically rated up to 150 watts. IC rated remodel housings are used in existing ceilings where insulation will be present and in contact with the fixture. Non-IC rated remodel housings are used for existing ceilings where, no insulation is present. Non-IC rated remodel housings require that there be no contact with insulation and at least 3 in (7.6 cm) spacing from insulation. Sloped-ceiling housings are available for both insulated and non-insulated ceilings that are vaulted. It is noted that the light housing of the downlight of the present disclosure may meet be designed to meet the requirements of any of the aforementioned standards. The light housing is typically designed to ensure that no flammable materials come into contact with the hot lighting fixture.

The light housing may be dimensioned to be available in various sizes based on the diameter of the circular opening where the luminaire 5 is installed. In some examples, the circular opening of the light housing may be sized in 6 and 8 inch diameter. It is noted that these dimensions are provided for illustrative purposes only and are not intended to limit the present disclosure. For example, the light housing may also have a circular opening in diameters equal to 2 inches, 3 inches, 4 inches or 5 inches.

In some embodiments, the light housing can also be “Air Tight”, which means it will not allow air to escape into the ceiling or attic, thus reducing both heating and cooling costs.

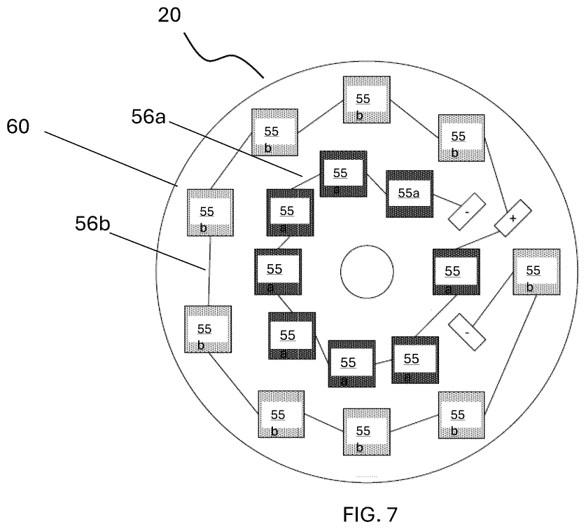

FIG. 7 is a top down view of a light engine 20 including at least one string of light emitting diodes (LEDs) as used in the light housing of the downlight designs depicted in FIGS. 2-6. The light engine 20 (also referred to as light source) is positioned within the light housing and orientated to emit light in a direction through opening of the light housing 10 at which the trim 5 is positioned. The light engine 20 produces light from solid state emitters.

The term “solid state” refers to light emitted by solid-state electroluminescence, as opposed to incandescent bulbs (which use thermal radiation) or fluorescent tubes, which use a low pressure Hg discharge. Compared to incandescent lighting, solid state lighting creates visible light with reduced heat generation and less energy dissipation. Some examples of solid state light emitters that are suitable for the methods and structures described herein include inorganic semiconductor light-emitting diodes (LEDs), organic light-emitting diodes (OLED), polymer light-emitting diodes (PLED) or combinations thereof. Although the following description describes an embodiment in which the solid state light emitters are provided by light emitting diodes, any of the aforementioned solid state light emitters may be substituted for the LEDs. FIG. 7 illustrates one example of the light emitting diodes (LEDs) 55 of a light engine 20 that can be utilized within the downlights 100 that are depicted in FIGS. 1-6.

Referring to FIG. 7, in some embodiments, the light source (also referred to as light engine) for the downlight is provided by plurality of LEDs 55 that can be mounted to the circuit board 60 by solder, a snap-fit connection, or other engagement mechanisms. In some examples, the LEDs 55 are provided by a plurality of surface mount device (SMD) light emitting diodes (LED).

The circuit board 60 for the light engine 20 may be composed of a metal core printed circuit board (MCPCB). MCPCB uses a thermally conductive dielectric layer to bond circuit layer with base metal (Aluminum or Copper). In some embodiments, the MCPCB use either Al or Cu or a mixture of special alloys as the base material to conduct heat away efficiently from the LEDs thereby keeping them cool to maintain high efficacy. In some embodiments, other materials, such as FR4 can also be employed.

It is noted that the number of LEDs 55 on the printed circuit board 60 may vary. For example, the number of LEDs 55 may range from 5 LEDs to 70 LEDs. In another example, the number of LEDs 55 may range from 35 LEDs to 45 LEDs. It is noted that the above examples are provided for illustrative purposes only and are not intended to limit the present disclosure, as any number of LEDs 55 may be present the printed circuit board 60. In some other examples, the number of LEDs 55 may be equal to 5, 10, 15, 20, 25, 30, 35, 40, 45, 50, 55, 60, 65 and 70, as well as any range of LEDs 55 with one of the aforementioned examples as a lower limit to the range, and one of the aforementioned examples as an upper limit to the range. In some embodiments, chip on board (COB) light emitting diodes may be used in the light engine.

The LEDs 55 may be arranged as strings 56a, 56b on the printed circuit board 60. When referring to a “string” of LEDs it is meant that each of the LEDs in the string are illuminated at the same time in response to an energizing act, such as the application of electricity from the driving electronics, e.g., driver, in the downlight. The LEDs 55 in a string of LEDs are electrically connected for this purpose. For example, when a string of LEDs 55 is energized for illumination, all of the LEDs in the string are illuminated. Further, in some embodiments, illuminating the first string of LEDs 55 does not illuminate the LEDs in the second string of LEDs 55, and vice versa, as they are independently energized by the driving electronics, and not electrically connected. It is also noted that the same LED may be shared by more than one string.

In some embodiments, the LEDs 55 of the downlight are selected to be capable of being adjusted for the color of the light they emit. The term “color” denotes a phenomenon of light or visual perception that can enable one to differentiate objects. Color may describe an aspect of the appearance of objects and light sources in terms of hue, brightness, and saturation. Some examples of colors that may be suitable for use with the method of controlling lighting in accordance with the methods, structures and computer program products described herein can include red (R), orange (O), yellow (Y), green (G), blue (B), indigo (I), violet (V) and combinations thereof, as well as the numerous shades of the aforementioned families of colors. It is noted that the aforementioned colors are provided for illustrative purposes only and are not intended to limit the present disclosure as any distinguishable color may be suitable for the methods, systems and computer program products described herein.

The LEDs 55 of the downlight may also be selected to allow for adjusting the “color temperature” of the light they emit. The color temperature of a light source is the temperature of an ideal black-body radiator that radiates light of a color comparable to that of the light source. Color temperature is a characteristic of visible light that has applications in lighting, photography, videography, publishing, manufacturing, astrophysics, horticulture, and other fields. Color temperature is meaningful for light sources that do in fact correspond somewhat closely to the radiation of some black body, i.e., those on a line from reddish/orange via yellow and more or less white to blueish white. Color temperature is conventionally expressed in kelvins, using the symbol K, a unit of measure for absolute temperature. Color temperatures over 5000 K are called “cool colors” (bluish white), while lower color temperatures (2700-3000 K) are called “warm colors” (yellowish white through red). “Warm” in this context is an analogy to radiated heat flux of traditional incandescent lighting rather than temperature. The spectral peak of warm-colored light is closer to infrared, and most natural warm-colored light sources emit significant infrared radiation. The LEDs 55 of the lamps provided by the present disclosure in some embodiments can be adjusted from 2000 K to 5000 K. In one example, the LEDs 55 of the luminaires can be adjusted to have a color correlated temperature ranging from 2700K to 5000K.

The LEDs 55 of the downlight may also be selected to be capable of adjusting the light intensity/dimming of the light they emit. In some examples, dimming or light intensity may be measured using lumen (LM). In some embodiments, the dimming or light intensity adjustment of the LEDs 55 can provide for adjusting lighting between 100 LM to 2000 LM. In another embodiment, dimming or light intensity adjustment of the LEDs 55 can provide for adjusting lighting between 500 LM to 1750 LM. In yet another embodiment, the dimming or light intensity adjustment of the LEDs 55 can provide for adjusting lighting between 700 LM to 1500 LM. In one example, the dimming or light intensity adjustment of the LEDs 55 can provide for adjusting lighting between 500 LM to 1000 LM.

In some embodiments, the LED light engines 20 for the downlight may provide the that downlight be an SMD (Surface Mount Diode) downlight and/or a COB (Chip on Board) downlights. In some embodiments, the LEDs 55 may be selected to be SMD type emitters, in which the SMDs are more efficient than COBs because the light source produces higher lumens per watt, which means that they produce more light with a lower wattage. In some embodiments, the SMD type LEDs 55 can produce a wider beam of light which is spread over a greater area when compared to light engines of COB type LEDs. This means that less material is needed for the heat sink, which in turn means that they are more economical. SMD downlights can be covered with a frosted diffuser which hides the LED chip array, and spreads the light evenly. SMD downlights can produce a wide spread of light. In some example, the wide beam angle of the light emitted from SMD downlights means they can be suitable for larger rooms like living rooms, bedrooms, kitchens and bathrooms.

A Chip On Board (COB) LED Downlight includes a single LED chip, mounted on the downlight, compared to an array of LED's like an SMD. COB LEDs are basically multiple LED chips (typically nine or more) bonded directly to a substrate by the manufacturer to form a single module. The ceramic/aluminum substrate of COB LEDs also acts as a higher efficiency heat transfer medium when coupled to an external heatsink, further lowering the overall operating temperature of the assembly. Since the individual LEDs used in a COB are chips, the chips can be mounted such that they take up less space and the highest potential of the LED chips can be obtained. When the COB LED package is energized, it appears more like a lighting panel than multiple individual lights as would be the case when using several SMD LEDs mounted closely together. In some embodiments, because the single cluster of LED's 55 are mounted in one point, they can require greater cooling, so a heat sink, usually made of aluminum, may be mounted to dissipate the heat.

A light engine of COB type LEDs 55 can provide a more focused light and with the use of reflectors, the light beam can be more controlled when compared to a light engine that is composed of SMD LEDs. Chrome reflectors surrounding the diode can be replaced and set at different angles to make the light beam narrower or wider. Due to the narrow beam and with the use of reflectors that are usually clear, COB lights generate crisper and cleaner as there is no frosting on the lenses, which cuts down the clarity of the LED light. Due to the clear lenses, more light can penetrate further which means they perform well in rooms with high ceilings.

It is noted that the above description of the light emitting diodes (LEDs) 55 is provided for illustrative purposes only, and is not intended to limit the present disclosure. For example, in some embodiments, other light sources may either be substituted for the LEDs 55, or used in combination with the LEDs 55, such as organic light-emitting diodes (OLEDs), a polymer light-emitting diode (PLED), and/or a combination of any one or more thereof.

The light engine 20 is powered by the driver electronics 15. The driver electronics 15 are in electrical communication with the main power supply that powers the luminaire 5. In some embodiment, the luminaire 5 may be connected to the main power supply of the installation by hard wired connection 9. However, other embodiments have been contemplated in which a connector is used to engage the luminaire 5 to the main power supply. For example, any standard, custom, or proprietary contact type and fitting size, as desired for a given target application or end-use may be used to connect the luminaire 5 to the main power supply. In some cases, connector may be configured as a threaded lamp base including an electrical foot contact. In some other cases, the connector may be configured as a bi-pin, tri- pin, or other multi-pin type connector. In some other cases, the connector may be configured as a twist- lock connector. It is noted that the above are only some examples of the type of connectors that may be used to connect the luminaire 9 to the main power supply.

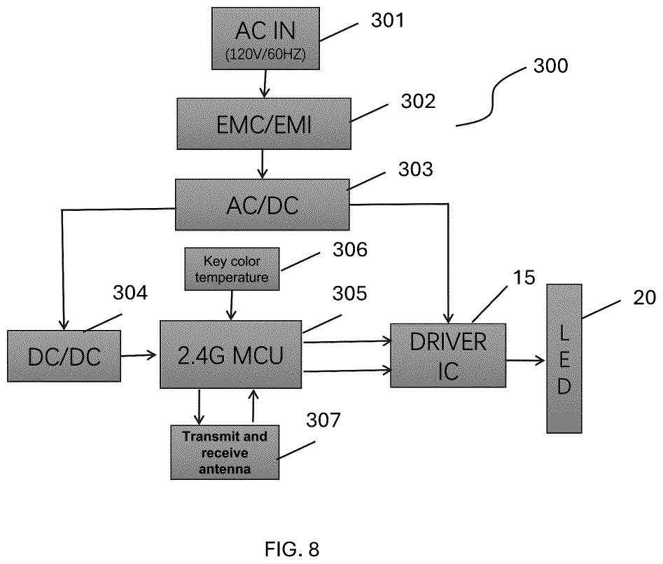

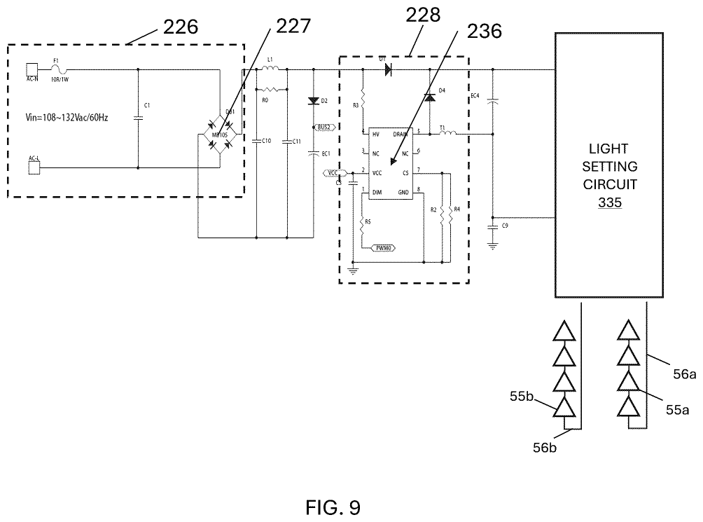

FIG. 8 is a block diagram of a circuit for the luminaire depicted in FIG. 2, in accordance with an embodiment of the present disclosure. FIG. 9 is a circuit diagram for the driver electronics 15 of the luminaire 5, in accordance with an embodiment of the present disclosure.

The driver electronics 15 can include the AC input 301, e.g., AC in 120V/60 Hz, which may be the connection to the power supply. Following, the AC input, is an EMC/EMI unit 302. EMC is how well a device blocks EMI. More specifically, in some embodiments, EMC—electromagnetic compatibility—measures how well electrical devices can function while being hit with EMI (released energy from another electrical device). While EMI is the problem, EMC sees how well that problem can be handled. In some embodiments, one way of dealing with electromagnetic interference is by using a capacitor to de-couple the unwanted RF signal from a given circuit. This capacitor is referred to as a decoupling capacitor.

Still referring to FIG. 8, the circuit further includes an AC/DC converter 303. The AC-DC converter 303 is an electronic circuit that converts alternating current (AC) into direct current (DC). In some examples, the components of AC-DC converter includes a step-down transformer, switches such as diodes and thyristors, a passive filter including an inductor and a capacitor, and a load. The selection of a particular type of AC-DC converter is determined by the voltage and current output requirements of the device, as well as the desired level of efficiency and dependability. Among the frequently employed AC- DC converter types are transformers, diode rectifiers, and voltage regulators.

The DC current from the AC/DC converter 303 is then sent to a DC/DC converter 304 and the driver integrated circuit (IC) 15. The DC-to-DC converter 304 is an electronic circuit or electromechanical device that converts a source of direct current (DC) from one voltage level to another. It is a type of electric power converter. Examples of isolated DC-DC converters are the forward and flyback converter. The forward converter is an isolated buck converter. The flyback is an isolated boost converter. Isolated power converters are those in which the input ground and output ground are not connected.

The DC-DC converter 304 sets the voltage to the level suitable for powering the a micro controller unit (MCU) 305. The MCU 305 actuates the driving electronics in controlling the lighting characteristics of the light being emitted by the light engine 20 of the luminaire 5. An MCU can be a semiconductor IC that can include a processor unit, memory modules, communication interfaces and peripherals. The MCU 305 can have an 8-bit architecture. The MCU 305 can also be an ARM-based MCU, which can be a 32-bit MCU.

In some embodiments, the MCU 305 functions by executing the program instructions stored in its non-volatile memory module. The MCU 305 may have memory that is ROM-based. In some embodiments, the MCU 305 can store program instructions using built-in flash memory. In some embodiments, the MCU 305 can use RISC (Reduced Instruction Set Computer) instruction architecture for its fundamental instruction processing. To develop the program for the MCU 305, embedded system developers use an assembler or C programming language. The finished program is can then loaded to the MCU 305 with a programming tool.

When powered up, the MCU 305 starts executing the instruction loaded as program data. It can utilize the RAM to store run-time variables as indicated by the program. The program can include a number of instructions. For example, the program can include instructions for employing a first wireless signal for connecting the luminaire 5 within a network of luminaires 5 and controllers 10, e.g., in a Bluetooth mesh network 4. For example, the program can include instructions for employing the second wireless signal for controlling the luminaires 5 in the network, e.g., controlling the light emission characteristics by the light engine 20. The second wireless signal can be a WiFi signal.

As described herein, the luminaire 5 functions in a mesh network 4. The luminaire 5 can send and receive two wireless signals. For example, the provisioning of the mesh network 4 may be accomplished through a first wireless signal, which can be a Bluetooth based wireless signal. More particularly, initial set up of a network of luminaires 5, the addition of new luminaires 5 to an existing mesh network, and the grouping of luminaires 5 in different scenes are all functions that are controlled through the first wireless signal, which can be a Bluetooth based signal. The program instructions in the MCU 305 can provide for this functionality.

The control of the characteristics for the light emission of the luminaires 5 can be controlled using the second wireless signal, which may be a WiFi based signal. In some embodiments, the light emission characteristics for the light emitted by the light engine 20 of the luminaire 5 is color correlated temperature (CCT). The light emission characteristics may be selected by a controller 10, in which the controller 10 sends the control signal from the controller 10 to the luminaire 5, e.g., to the network 4 of the luminaires 5, via the second wireless signal. For example, the light engine 20 can include two strings 56a, 56b of light emitting diodes 55. The amount of current supplied to the two strings 56a, 56b may be modulated to provide different color correlated temperatures (CCTs) and light intensity (lumens) for the light being emitted by the luminaire 5, as well as tuming the luminaires ON and OFF. All of these functions may be selected from the controller 10, which can be a wall switch.

More particularly, the luminaires 5 employ light engines 20, as depicted in FIG. 7, having a plurality of light schemes programmed into the memory of the MCU 305 that are modulated to provide different light characteristics for the light being emitted by the light engine 20 in response to commands received from the second wireless signal from the controller. A “light scheme”' is a grouping of lights, e.g., an LED string 56a, 56b, in which the lighting scheme provides that the LEDs 55a, 55b in the light scheme when illuminated provide a specific lighting characteristic, e.g., a specific value for one of color, color correlated temperature or intensity. By providing multiple lighting schemes each having different associated light characteristics, and controlling the amount of current being directed to each of the different lighting schemes, the collective light characteristics for the totality of light schemes emitting light for the light engine 20 may be adjusted.

In one embodiments, the light engine 20 may be composed of multiple strings, e.g., two strings 56a, 56b, of LEDs 55a, 55b, in which each string 56a, 56b of LEDs 55a, 55b can provide a separate lighting scheme. In another example, each LED filament in the light engine 20 can provide a different LED lighting scheme.

In one embodiment, each scheme of LEDs may be illuminated to provide an intensity of light emitted by the light engine 20 for the lamp 100 that can range from 300 lumens (LM) to 1500 lumens (LM). As noted each scheme of LEDs 55a, 55b may be selected to provide a different value of lumens when the LED string 56a, 56b is illuminated. The program instructions in the memory of the MCU 305 can control the driver integrated circuit (IC) 15 that can distribute current to each of the lighting scheme to mix the light being emitted by the lighting schemes. By mixing the light produced by the separate lighting scheme, the light characteristics of the light engine 20 may be a mixture of the light characteristics of the individual lighting schemes. The greater the current applied to a particular lighting scheme, the greater the contribution of the lighting characteristics for that lighting scheme to the lighting characteristics of the total light, e.g., total light spectra, being emitted by the light engine 20. In some examples, the program instructions employed for mixing the different LEDs 55a, 55b, e.g., strings of LEDs, 56a, 56b, to provide lighting characteristics such as color correlated temperature (CCT) and color may be stored in a memory module 306, such as a key color temperature module, which is in communication with the MCU 305.

In some other examples, each of the lighting schemes 56a, 56b of the LEDs 55a, 55b of the light engine 20 may illuminated in mixtures provided by current distributions through the driver integrated circuit 15 to provide an intensity of total light provided by the totality of lighting schemes that is equal to 350 lumens (LM) 500 lumens (LM), 550 lumens (LM), 700 lumens (LM), 750 lumens (LM), 1200 lumens (LM), 5000 lumens (LM), as well as any range of intensity values included one of the aforementioned values for the lower end of the range, and one of the aforementioned values for the upper end of the range, as well as individual values for intensity within those ranges. The intensity of the light emitted by the light engine 20 is a characteristic of light emitted by the luminaire 15 that can be controlled by first wireless signal using the controller 10.

In some embodiments, the LEDs 55a, 55b of the lamp 100 are selected to be capable of being adjusted for the color of the light they emit. The term “color” denotes a phenomenon of light or visual perception that can enable one to differentiate objects. Color may describe an aspect of the appearance of objects and light sources in terms of hue, brightness, and saturation.

More specifically, in some embodiments, different lighting schemes, e.g., LED strings 56a, 56b, of LEDs 55a, 55b include different colors. For example, each lighting scheme includes an assigned color that is different from the other lighting schemes. For example, a first string of LEDs 56a may include LEDs 55a that emit blue light, and the second string of LEDs 56b may include LEDs 55b that emit red light.

Some examples of colors that may be suitable for use with the method of controlling lighting in accordance with the methods, structures and computer program products described herein can include red (R), orange (O), yellow (Y), green (G), blue (B), indigo (I), violet (V) and combinations thereof, as well as the numerous shades of the aforementioned families of colors. It is noted that the aforementioned colors are provided for illustrative purposes only and are not intended to limit the present disclosure as any distinguishable color may be suitable for the methods, systems and computer program products described herein.

Responsive the commands received from the controller 10 sent via the second control signal, e.g., WiFi signal, the mixing integrated circuit (IC) 15 can distribute current to each of the lighting scheme to mix the light, e.g., color of light, being emitted by the lighting schemes. By mixing the light produced by the separate lighting schemes, the color light characteristic of the light engine 20 may be a mixture of the color light characteristics of the individual lighting schemes. The greater the current applied to a particular lighting scheme with a specific color lighting characteristic, the greater the contribution of that color lighting characteristic for that lighting scheme to the color lighting characteristics of the total light, e.g., total color light spectra, being emitted by the light engine 20.

The LEDs of the luminaire 5 may also be selected to allow for adjusting the “color correlated temperature (CCT)” of the light they emit. The color temperature of a light source is the temperature of an ideal black-body radiator that radiates light of a color comparable to that of the light source. Color correlated temperature is a characteristic of visible light that has applications in lighting, photography, videography, publishing, manufacturing, astrophysics, horticulture, and other fields. Color correlated temperature is meaningful for light sources that do in fact correspond somewhat closely to the radiation of some black body, i.e., those on a line from reddish/orange via yellow and more or less white to blueish white. Color correlated temperature is conventionally expressed in kelvins, using the symbol K, a unit of measure for absolute temperature. Color correlated temperatures over 5000 K are called “cool colors” (bluish white), while lower color temperatures (2700-3000 K) are called “warm colors” (yellowish white through red). “Warm” in this context is an analogy to radiated heat flux of traditional incandescent lighting rather than temperature. The spectral peak of warm-colored light is closer to infrared, and most natural warm-colored light sources emit significant infrared radiation. The LEDs of the luminaires provided by the present disclosure in some embodiments can range from 2000K to 6500K.

In some embodiments, each lighting scheme of LEDs 55a, 55b may be selected to provide a different value of color correlated temperature (CCT) when the LED string 56a, 56b is illuminated. The mixing integrated circuit (IC) 35 can distribute current to each of the lighting schemes to mix the light being emitted by the lighting schemes. By mixing the light produced by the separate lighting schemes, the light characteristics of the light engine 20 may be a mixture of the light characteristics of the individual light schemes. For example, by mixing two light schemes of two different color correlated temperatures (CCT), the value for the color correlated temperature (CCT) for the total light being emitted by the light engine 20 may be a value between the two values specifically provided by the separate light schemes. The greater the current applied to a particular lighting scheme, the greater the contribution of the lighting characteristics for that particular lighting scheme is contributed to the lighting characteristics of the total light, e.g., total light spectra, being emitted by the light engine 20.

In some examples, each of the lighting schemes 56a, 56b of the LEDs 55a, 55b of the light engine 20 may illuminated in mixtures provided by current distributions through the mixing driver integrated circuit 15 to provide a color correlated temperature of total light provided by the totality of lighting schemes that is equal to 2500K, 3000K, 3500K, 4000K, 5000K or 6500K, as well as any range of color correlated temperature (CCT) values including one of the aforementioned values for the lower end of the range, and one of the aforementioned values for the upper end of the range, as well as individual values for color correlated temperatures (CCT) within those ranges.

Referring to FIG. 8, as noted the luminaire 5 receives and sends a first and second wireless signal,

e.g., Bluetooth based signal and WiFi signal, for provisioning the network 4 of luminaires 5 and controlling the luminaires 5. In some embodiments, to send and receive the first and second wireless signals, the luminaire 5 includes a communications module 307 that includes at least one transceiver for communication with the first and second wireless signals. A transceiver is a device that can both transmit and receive communications, in particular a combined radio transmitter and receiver. In some instances, a transceiver is a device comprising both a transmitter and a receiver that are combined and share common circuitry or a single housing. When no circuitry is common between transmit and receive functions, the device is a transmitter-receiver. It is noted that both configurations are suitable for use with the structure depicted in FIG. 8, as well as separate transmitters and receivers, so long as selected devices in the communications module 307 can provide the functions of receiving and transmitting signals for the 802.11 standard, e.g., second wireless signal, and the Bluetooth/BLE standard, e.g., first wireless signal For example, at least one series of components within the communications module 307 provides a Bluetooth/BLE transceiver and at least one series of components within the communications module provides the WiFi transceiver. In one embodiment, the communications module 307 includes a 24 MHz crystal oscillator. The radio transceiver can be a BR/Bluetooth 5.2/Long range transceiver. Some performance characteristics for the communications module 307 can include:
+12 dBm TX power in 1 dB/steps.
99 dBm RX sensitivity @BLE 1 Mbps.
96 dBm RX sensitivity @BLE 2 Mbps.
Integrated balun with single-ended output and direct connection to antenna.
5.8 Ma RX system current @BLE 1 Mbps −99 dBm sensitivity (3v DC-DC 90% efficiency).
5.2 Ma RX system current @BLE 1 Mbps −97 dBm sensitivity (3v DC-DC 90% efficiency).
10.9 Ma RX system current @BLE 1 Mbps −97 dBm sensitivity (3v DC-DC 90% efficiency, 0 dBm).

In an example, the MCU 305 and the communications module 307 may be provided by a system on chip (SOC) integrating a Bluetooth® 5.2 compliant 2.4 GHz transceiver, 24 MHz 32 bit MCU with a RAM of 12 KB. The memory in the MCU 305 may include a 4 Mb Flash ROM, a 12 kB date RAM, and a 4 KB supporting retention mode. In one example, the MCU 305 and the communications module 307 can be provided by a J0020 high performance low power BR/BLE 5.2 system on chip (SOC) available from Li Xin Long Trading Limited.

Referring to FIG. 8, the MCU 305 is connected to a driver integrated circuit 15 that is in communication with the light engine 20.

FIG. 9 is a circuit diagram of the driver integrated circuit 15 of the luminaire 5. The driver integrated circuit 15 can include an AC input circuit 226, which includes a rectifying bridge 227. This may be an element of the AC/DC converter 303 depicted in FIG. 8. In some embodiments, the Vin=108˜132 Vac/60 Hz. The AC input circuit 226 feed AC current into a power supply circuit 228. The power supply circuit 228 includes an analog power supply integrated circuit 236 that delivers constant current to a light setting circuit 335. The light setting circuit 335 adjusts current to the LEDs 55 in accordance with the instructions from the MCU 305 for setting the light characteristics for the light emitted by the light engine 20. The light engine 20 including the LEDs 55a, 55b (in some embodiments LED strings 56a, 56b) receives current from the power supply circuit for powering the LEDs 55a, 55b.

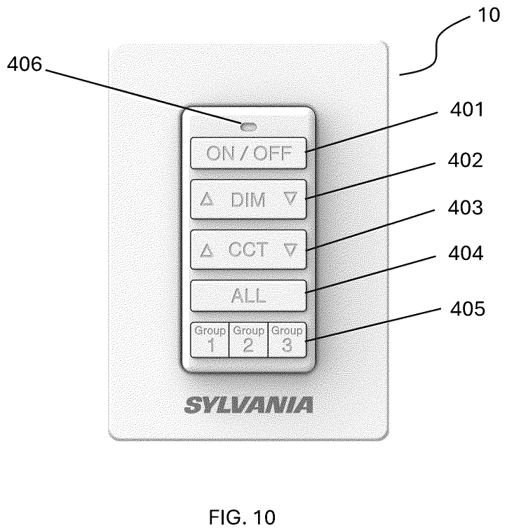

FIG. 10 is a front view of a controller 10 for the lighting network control system that employs a first wireless signal to provision a network 4 of luminaires 5 and a second wireless signal to control the lighting characteristics for the light emitted by the network 4 of luminaires 5.

In some embodiments, the light control system includes a controller 10 having at least one transceiver 148 for communication with a mesh network 4 using a first wireless signal based on a BLE standard for configuring the mesh network 4. The controller 10 also sends the second wireless signal based on a WiFi standard for issuing control commands to the luminaires 5. The second wireless signal may be sent by a second transceiver 149. It is noted that in some embodiments, a single transceiver within the controller 10 may provide the functions for both to the first and second transceivers 148, 149.

In some embodiments, the controller 10 is a wall switch, as depicted in FIG. 10. In some embodiments, the controller 10 may be configured as a remote control. In one example, the controller 10 may be referred to as a wall remote control. The controller 10 may be powered by a power source that is separate from the power of the residential or commercial electrical service. For example, the controller 10 may be powered by a battery.

Referring to FIG. 10, the user interface 110 of the wall remote control (controller 10) may include an ON/OFF switch 401, a dimming switch 402, a switch for changing color correlated temperature (CCT switch 403), a switch (All luminaire switch 404) providing for all of the luminaires 5 in the network being controlled simultaneously, and a set of buttons/switches (group control (405)) for controlling individual groups of luminaires 5.

The ON/OFF switch 401, the CCT switch 403 and the dimming switch 402 are all control switches from which a user can select lighting characteristics for light to be emitted by the luminaires 5, which is a command that is sent from the controller 10 to the network of luminaires using the second wireless signal, which is a WiFi signal. It is noted that light intensity, ON/OFF and color correlated temperature (CCT) are only some examples of lighting characteristics for light being emitted by the light engine 20, and it is not intended that the controller 10 be limited to only these examples, as other lighting characteristics may be selected from the controller 10. For example, the controller 10 may also include an interface for selecting color of the light emitted by the light engine 20. In some embodiments, the controller 10 works within a lighting control system, in which the second wireless signal is based on the WiFi standard. The second wireless signal is for issuing control commands from the controller 10 to the at least one luminaire 5. The lighting control system employs the second wireless signal that is sent from the controller to the mesh network without the need for an additional bridge. More particularly, for sending the second wireless signal, e.g., WiFi signal, between the controller 10 and the mesh network 4, there is no additional need for an external WiFi connection. No additional bridges or routers are needed for communication of the luminaires 5 and the controller 10.

Referring to FIG. 10, in some embodiments, the ALL luminaire switch 404 can allow for example, the all luminaire switch 404 can be used to control up to 50 luminaires within 50′ of the controller 10. It is noted that in some examples, the range may be limited by interior walls.

In some embodiments, the group control 405 switch allows for pairing up to 3 different groups of luminaires 5 in the network 4 using a single control 10. For example, the group control 405 may include grouping luminaires 5 according to a a scene, which may be a room containing luminaires. Examples of scenes that can be rooms can include bedrooms, bathrooms, entertainment rooms, kitchens, hallways, garages and other similar rooms. The group control 405 may include grouping luminaires 5 may also include a grouping of luminaires 5 according to form factor. Example of luminaires form factors that can be selected to be controlled by the group control 405 can include hanging pendant lamp, desk lamp, table lamp, floor lamp, chandelier lamp, recessed can downlight, light sources having a heat sinks, and 2×2 and/or 2×4 tube lighting office type fixtures.

The interface allows for the ON/OFF switch 401 to turn on or turn off all the luminaries 5 in the network at the same time, or to turn on or tun off singular groups of luminaires 5 in the network 4.

In some embodiments, the controller 10 works within a lighting control system, in which the first wireless signal for initiating the network 4 of luminaires, provisioning new luminaires 5 to the network, and grouping of luminaires 5 can be accomplished by a first wireless signal sent between the controller 10 and the luminaires, which is based on a Bluetooth standard. The lighting control system employs the first wireless signal that is sent from the controller 10 to the mesh network 4 without the need for an additional bridge. More particularly, for sending the first wireless signal, e.g., Bluetooth signal, between the controller 10 and the mesh network 4, there is no additional need for an external WiFi connection. No additional bridges or routers are needed for communication between the luminaires 5 and the controller 10.

In some embodiments, the controller 10 further includes a network pair function that sends a pairing command over the first wireless signal. The pairing command initiates upon the at least one luminaire 5 being powered from an off state, the pairing command continuing from power up for a preset time period. In some embodiments, the pairing command is solely initiated by the at least one luminaire 5 being powered from the off state without additional user interaction with the luminaire through external interfaces directly on the at least one luminaire.

The controller 10 depicted in FIG. 10 also includes at least one sensor 406.

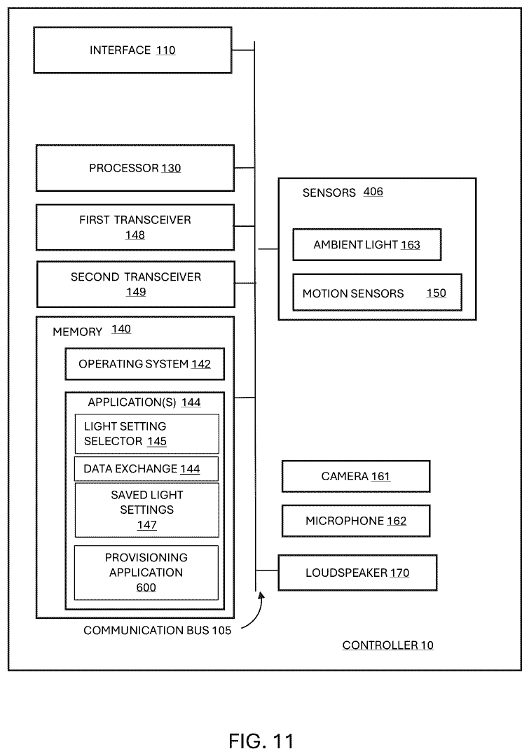

FIG. 11 is a block diagram of a controller 10 for the lighting network control system that employs a first wireless signal to provision a network 4 of luminaires 5 and a second wireless signal to control the lighting characteristics for the light emitted by the network 4 of luminaires 5. The control device depicted in FIG. 11 provides one embodiment of the controller 10 for sending the luminaires 5 networking commands and control commands using the first wireless signal and second wireless signal.

In one embodiments, the lighting control system, i.e., controller 10, includes a first transceiver, i.e., Bluetooth/BLE transceiver 148, based on Bluetooth/BLE radio frequency standard, and a second transceiver, i.e., WiFi transceiver 149. The controller 10 can also includes a data exchange application 144 for sharing address information received from the luminaires 5. More particularly, address information from the mesh network 4 of luminaires 5 initiated through first wireless signals, e.g., Bluetooth based signals, and be shared with the programs for controlling the lighting characteristics of the light emitted by the luminaires as controlled through the second wireless signals, e.g., WiFi based signals.

The controller 10 can employ any of a wide range of platforms. Although the controller 10 is depicted in FIG. 10 as a wall type switch or wall remote control. The controller 10 may be configured in another type of form factor, such as a laptop/notebook computer, sub-notebook computer, a tablet, phablet computer; a mobile phone, a smartphone; a personal digital assistant (PDA), a portable media player (PMP), a cellular handset; a handheld gaming device; a gaming platform; a wearable computing device, a body-borne computing device, a smartwatch, smart glasses, smart headgear, and a combination thereof. It is noted that the block diagram that is depicted in FIG. 11 only includes some components that can be incorporated into the controller 10. It is noted that some of the components depicted in FIG. 11 may be omitted, and that some components may be added to the block diagram illustrated in FIG. 11 consistent with the specific type of controller 10.

The controller 10 may include memory 140 and one or more processors 130. Memory 140 can be of any suitable type (e.g., RAM and/or ROM, or other suitable memory) and size, and in some cases may be implemented with volatile memory, non-volatile memory, or a combination thereof.

A given processor 130 of computing device 100 may be configured as typically done, and in some embodiments may be configured, for example, to perform operations associated with the controller 10 one or more of the modules thereof (e.g., within memory 140 or elsewhere). In some cases, memory 140 may be configured to be utilized, for example, for processor workspace (e.g., for one or more processors 130) and/or to store media, programs, applications, and/or content on computing device 100 on a temporary or permanent basis.

The one or more modules stored in memory 140 can be accessed and executed, for example, by the one or more processors 130 of computing device 100. In accordance with some embodiments, a given module of memory 140 can be implemented in any suitable standard and/or custom/proprietary programming language, such as, for example C, C++, objective C, JavaScript, and/or any other suitable custom or proprietary instruction sets, as will be apparent in light of this disclosure. The modules of memory 140 can be encoded, for example, on a machine-readable medium that, when executed by one or more processors 130, carries out the functionality of the controller 10, in part or in whole. The computer-readable medium may be, for example, a hard drive, a compact disk, a memory stick, a server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose-built logic. Some embodiments can be implemented with a microcontroller having input/output capability (e.g., inputs for receiving user inputs; outputs for directing other components) and a number of embedded routines for carrying out the device functionality.

In a more general sense, the functional modules of memory 140 (e.g., such as operating system (OS) 142 and/or one or more applications 144, each discussed below) can be implemented in hardware, software, and/or firmware, as desired for a given target application or end-use. The memory 140 may include an operating system (OS) 142. The OS 142 can be implemented with any suitable OS, mobile or otherwise, such as, for example, Android OS from Google, Inc.; iOS from Apple, Inc.; BlackBerry OS from BlackBerry Ltd.; Windows Phone OS from Microsoft Corp; Palm OS/Garnet OS from Palm, Inc.; an open source OS, such as Symbian OS; and/or a combination of any one or more thereof. As will be appreciated in light of this disclosure, OS 142 may be configured, for example, to aid with sending luminaire performance commands to the luminaires 5 using the first and second wireless signals.

The applications 143 within the memory 140 of the control device 100 further include a provisioning application 600, a data exchange application 144 and a light comments and settings application 147. In some embodiments, the control device 100 employing the processors 130 and the instructions stored in the memory 140 is configured to send luminaire performance commands to the luminaires 4 over networks 4 that are initiated and selected using the first wireless signal commands, which can employ the data exchange application 144.

The applications 143 stored in the memory 140 of the control device 100 include light commands and settings 145. The light commands and settings 147. The light and command settings 145 application allow the user of the controller 10 to select light characteristics, such as light color, light color temperature, light intensity, etc., to be emitted by the luminaires 5 within the control of the network 4 of luminaires 5. The content, i.e., data, to be transmitted from the light control 100 with the luminaire performance command are selected using the light and command settings 145 application. The light and command settings 145 can also select which luminaires 5, e.g., which scene and lamp form factor, will receive the luminaire performance command from the control device 100. The data exchange application 144 provides that the user of the control device 100 can select the light characteristics to be emitted by the luminaires 5. The applications 143 can also include saved light settings 147, which are preferences for lighting saved by the user to be easily reconstituted when desired.

In accordance with some embodiments, the controller 10 may include one or more sensors 406. For example, the sensors 406 may include an ambient light sensor 163 and a motion sensor 150. In some embodiments, the controller 10 may include a camera 161 (or image capture device), microphone 162 (or sound capture device), and/or any other suitable sensor.

In accordance with some embodiments, the controller 10 may include one or more loudspeakers 170 or other audio output devices, in accordance with some embodiments.

In some embodiments, the aforementioned elements of the controller 10 may be interconnected with a communications bus 105.

In another aspect of the present invention is a method of lighting control that can include providing a controller 10 having a user interface for selecting lighting characteristics, and at least one transceiver for communication using a first wireless signal based on a Bluetooth standard and a second wireless signal based on a WiFi standard. In a following step, the method can further include initiating a mesh network 4 of at least one luminaire 5. The at least one luminaire 5 can include a light source including a light emitting diode (LED) 55. The method may also include a controller 10 for controlling the electrical signal to the light source. The luminaire 5 can include memory storing a network address and a transceiver for communicating with the controller 10 using the first and second wireless signal. In some examples, initiating the mesh network includes linking the luminaires 5 to the controller to the mesh network using the second wireless signal.

The method can further include controlling the at least one luminaire 5 in the mesh network 4 from the user interface, e.g., controller 10, for selecting light characteristics for light emitted by the light source. In some examples, controlling the at least one luminaire 5 includes sending control signals for the lighting characteristics selected from the user interface using the second wireless signal to the at least one luminaire 5 in the mesh network 4.

In some embodiments, initiating the mesh network 4 of the at least one luminaire 5 in the mesh network can include connecting the at least one luminaire 5 to a power source (residential power supply), wherein powering the at least one luminaire 5 with the power source starts an initiation process during which the at least one luminaire sends 5 out a mesh command including the network address using the first wireless signal. In some examples, the mesh command includes a beaconing step in which each luminaire 5 broadcasts via the first wireless signal the network address as provisioning data, an invitation step in which the network addresses are transmitted to the controller 10, and authentication stage that is performed at the controller 10, and a distribution of the provisioning data across the at least one luminaire 5 for linking of luminaires in the mesh network 4.

In some embodiments, the luminaire controller 10 further includes network pair function that sends a pairing command over the first wireless signal for adding additional luminaires to the mesh network. The pairing command initiating upon the at least one luminaire 5 being powered from an off state. The pairing command continuing from power up for a preset time period, e.g., 60 seconds.

In one example, grouping of luminaires may include turning luminaires 5 for the intended group on. Upon powering of the luminaire 5, the luminaire beings a pairing mode. The pairing mode may last for up to 30 seconds following the initial powering. During pairing mode, the luminaires being grouped may pulse at a low light level.

The luminaires 5 can automatically pair after the pairing mode time period. In some examples, the luminaires 5 that have linked to the mesh network may indicate they have completed the pairing process by blinking the light engine 20.

Unpairing of luminaires 5 from groups may be accomplished by pressing the group control button 405 for the group the user wishes to de-group. For example, to de-group a luminaire 5 from a group, the relevant group control button 405 on the controller 10 may be pressed for 6 seconds to start the de-group process. After the group control button 405 has been pressed for the predetermined time, the user can then press the ON/OFF button 401 of the controller 10. The above process sequence will de-group the selected luminaire 5.

In some examples, the pairing command is solely initiated by the at least one luminaire said powered from the off state without additional user interaction with the luminaire through external interfaces directly on the at least one luminaire.

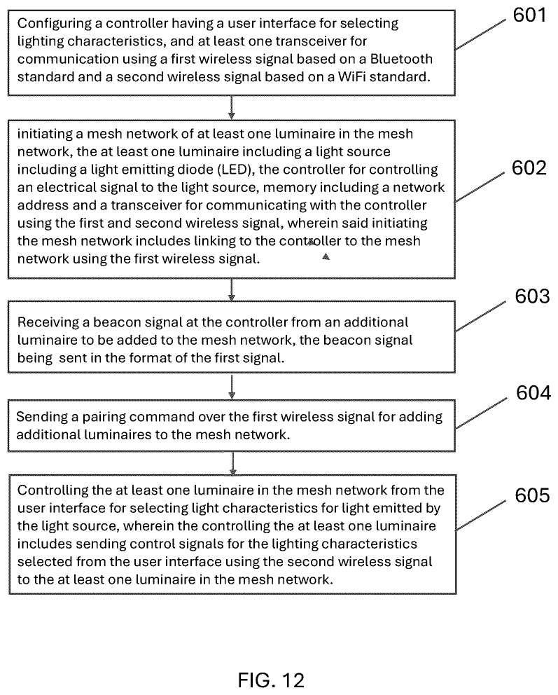

FIG. 12 illustrates one embodiment of a block diagram of a computer implemented method for providing a wireless control system that employs two wireless signals for operation, in accordance with one embodiment of the present disclosure. The method for providing the wireless control systems may include an instruction set including in the applications 143 within the memory 140 of the control device 100 including the provisioning application 600, the data exchange application 144 and the light comments and settings application 147.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). These functions may be executed by the microprocessor 130. In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Referring to FIG. 12, in some embodiments, the computer implemented method can include configuring a control device 100 having a user interface for selecting lighting characteristics, and at least one transceiver 148, 149 for communication using a first wireless signal based on a Bluetooth standard and a second wireless signal based on a WiFi standard at block 601.

The method may further include block 602. Block 602 may include initiating a mesh network of at least one luminaire 5 in the mesh network, the at least one luminaire 5 including a light source including a light emitting diode (LED), the control device 100 for controlling an electrical signal to the light source, memory including a network address and a transceiver 148, 149 for communicating with the controller 100 using the first and second wireless signal, wherein said initiating the mesh network includes linking to the controller 100 to the mesh network using the first wireless signal.

The method can further include receiving a beacon signal at the controller 100 from an additional luminaire 5 to be added to the mesh network, the beacon signal being sent in the format of the first signal at block 603.

Block 604 may include sending a pairing command over the first wireless signal for adding additional luminaires to the mesh network. The pairing command may be sent from the controller 100 to the luminaires 5.

The method may further include controlling the at least one luminaire 5 at block 605. Controlling the luminaire may include control in the mesh network from the user interface for selecting light characteristics for light emitted by the light source, wherein the controlling the at least one luminaire 5 includes sending control signals for the lighting characteristics selected from the user interface using the second wireless signal to the at least one luminaire in the mesh network.

The present invention may be a system, a method, and/or a computer program product at any possible technical detail level of integration. The computer program product may include a computer readable storage medium (or media) having computer readable program instructions thereon for causing a processor to carry out aspects of the present invention.

For example, the present disclosure provides a computer program product that includes a non- transitory computer readable storage medium having computer readable program code embodied therein for a method of configuring a controller having a user interface for selecting lighting characteristics, and at least one transceiver for communication using a first wireless signal based on a Bluetooth standard and a second wireless signal based on a WiFi standard. The method provided by the computer program product can further include initiating a mesh network of at least one luminaire in the mesh network, the at least one luminaire including a light source including a light emitting diode (LED), a luminaire controller for controlling an electrical signal to the light source, memory including a network address and a transceiver for communicating with the controller using the first and second wireless signal, wherein said initiating the mesh network includes linking to the controller to the mesh network using the first wireless signal. In some embodiments, the method provided by the computer program product can also include controlling the at least one luminaire in the mesh network from the user interface for selecting light characteristics for light emitted by the light source, wherein the controlling the at least one luminaire includes sending control signals for the lighting characteristics selected from the user interface using the second wireless signal to the at least one luminaire in the mesh network.

In some embodiments, the computer implemented method includes initiating the mesh network of the at least one luminaire in the mesh network comprises connecting the at least one luminaire to a power source, wherein powering the at least one luminaire with the power source starts an initiation process during which the at least one luminaire sends out a mesh command including the network address using the first wireless signal. In some embodiments, the mesh command includes a beaconing step in which each luminaire broadcasts via the first wireless signal the network address as provisioning data, an invitation step in which the network address is transmitted to the luminaire controller, and authentication stage that is performed at the luminaire controller, and a distribution of the provisioning data across the at least one luminaire for linking of luminaires in the mesh network. In some embodiments, the mesh command provides flood pooling of the at least one luminaire in the mesh network. In some embodiments, the luminaire controller further comprises network pair function that sends a pairing command over the first wireless signal for adding additional luminaires to the mesh network, the pairing command initiating upon the at least one luminaire being powered from an off state, the pairing command continuing from power up for a preset time period.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a method, system and computer program product for controlling lighting, it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A lighting control system comprising:
a controller having at least one transceiver for communication with a mesh network using a first wireless signal based on a Bluetooth standard for configuring the mesh network and sending a second wireless signal based on a WiFi standard for issuing control commands; and
at least one luminaire in the mesh network, the at least one luminaire including a light source including a light emitting diode (LED), a luminaire controller for controlling an electrical signal to the light source, memory including a network address and a transceiver for communicating with the luminaire controller using the first and second wireless signal.

2. The lighting control system of claim 1, wherein the Bluetooth standard is Bluetooth mesh.

3. The lighting control system of claim 1, wherein the WiFi standard is based on an IEEE 802 standard.

4. The lighting control system of claim 1, wherein the second wireless signal using the WiFi standard includes a 2.4 GHz WiFi band.

5. The lighting control system of claim 1, wherein the luminaire controller is a wall switch.

6. The lighting control system of claim 5, wherein the wall switch is battery powered.

7. The lighting control system of claim 6, wherein the second wireless signal based on the WiFi standard for issuing control commands includes a command to the at least one luminaire for at least one characteristic of light being emitted by the light source.

8. The lighting control system of claim 7, wherein the wall switch includes interface controls through which a user selects the at least one characteristic for light emitted from the light source selected from the group consisting of ON, OFF, light intensity, color correlated temperature and combinations thereof.

9. The lighting control system of claim 1, wherein the first wireless signal is sent from the luminaire controller to the mesh network without a bridge for the first wireless signal between the luminaire controller and the mesh network.

10. The lighting control system of claim 1, wherein the second wireless signal is sent from the luminaire controller to the mesh network without a bridge for the second wireless signal between the luminaire controller and the mesh network.

11. The lighting control system of claim 1, wherein the luminaire controller includes an interface for a user to select at least one grouping of the at least one luminaire for separate control using the second wireless signal.

12. The lighting control system of claim 1, wherein luminaire controller further comprises a network pair function that sends a pairing command over the first wireless signal, the pairing command initiating upon the at least one luminaire being powered from an off state, the pairing command continuing from power up for a preset time period.

13. The lighting control system of claim 12, wherein the pairing command is solely initiated by the at least one luminaire powered from the off state without additional user interaction with the luminaire through external interfaces directly on the at least one luminaire.

14. A method of lighting control comprising:
providing a controller having a user interface for selecting lighting characteristics, and at least one transceiver for communication using a first wireless signal based on a Bluetooth standard and a second wireless signal based on a WiFi standard;
initiating a mesh network of at least one luminaire in the mesh network, the at least one luminaire including a light source including a light emitting diode (LED), a luminaire controller for controlling an electrical signal to the light source, memory including a network address and a transceiver for communicating with the controller using the first and second wireless signal, wherein said initiating the mesh network includes linking to the controller to the mesh network using the first wireless signal; and
controlling the at least one luminaire in the mesh network from the user interface for selecting light characteristics for light emitted by the light source, wherein the controlling the at least one luminaire includes sending control signals for the lighting characteristics selected from the user interface using the second wireless signal to the at least one luminaire in the mesh network.

15. The method of claim 14, wherein the initiating the mesh network of the at least one luminaire in the mesh network comprises connecting the at least one luminaire to a power source, wherein powering the at least one luminaire with the power source starts an initiation process during which the at least one luminaire sends out a mesh command including the network address using the first wireless signal.

16. The method of claim 15, wherein the mesh command includes a beaconing step in which each luminaire broadcasts via the first wireless signal the network address as provisioning data, an invitation step in which the network address is transmitted to the luminaire controller, and authentication stage that is performed at the luminaire controller, and a distribution of the provisioning data across the at least one luminaire for linking of luminaires in the mesh network.

17. The method of claim 16, wherein the mesh command provides flood pooling of the at least one luminaire in the mesh network.

18. The method of claim 14, wherein luminaire controller further comprises network pair function that sends a pairing command over the first wireless signal for adding additional luminaires to the mesh network, the pairing command initiating upon the at least one luminaire being powered from an off state, the pairing command continuing from power up for a preset time period.

19. The method of claim 18, wherein the pairing command from the mesh network is transmitted to the additional luminaire, wherein the additional luminaire is joined to the mesh network by selected a grouping button the an exterior surface of the additional luminaire.

20. The method of claim 18, wherein the pairing command is solely initiated by the at least one luminaire powered from an off state without additional user interaction with the luminaire through external interfaces directly on the at least one luminaire.
